(19) United States
(12) Patent Application Publication
(10) Pub. No.: US 2025/0331007 A1
(43) Pub. Date: Oct. 23, 2025

(54) MINIMIZING SPECTRUM FRAGMENTATION FOR REDUCED CAPABILITY DEVICES

(71) Applicant: T-Mobile Innovations LLC, Overland Park, KS (US)

(72) Inventors: Liezel REOGANIS, Redmond, WA (US); Mochamad MIRZA, Bothell, WA (US); Hui-Hsia SUNG, Bellevue, WA (US)

(21) Appl. No.: 18/637,985

(22) Filed: Apr. 17, 2024

(51) Int. Cl. H04W 72/51; H04W 28/26; H04W 72/1273; H04W 72/21

(52) U.S. Cl. CPC H04W 72/51; H04W 28/26; H04W 72/1273; H04W 72/21

(57) ABSTRACT

Methods provided herein include minimizing spectrum fragmentation associated with reduced capability (RedCap) devices. The method includes receiving, at an access node, a request for resources from a wireless device in a network and identifying the wireless device as a reduced capability (RedCap) device. The method further includes allocating a physical resource block (PRB) to the RedCap device based on the request, and scheduling the PRB at an edge of a spectrum bandwidth based on the identification.

### TECHNICAL BACKGROUND

As wireless networks evolve and grow, ongoing challenges arise in communicating data across different types of networks. For example, a wireless network may include one or more access nodes, such as base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Within the above-described networks, the wireless device class including internet of things (IoT) devices has experienced rapid growth. While the number of smartphones is tied to the number of subscribers, IoT devices are not similarly limited. Various IoT devices were developed for use with 4G LTE networks and these developments have expanded for 5G networks. IoT devices build the network of physical objects or things that are embedded with sensors, software, and other technologies for the purpose of connecting and exchanging data with other devices and systems over the Internet. Cellular IoT is a way of connecting physical things, such as sensors to the internet by having them utilize the same mobile networks as wireless devices. In the consumer market, IoT technology is frequently utilized to equip the “smart home”, including devices such as lighting fixtures, thermostats, home security systems and cameras. The devices can often be controlled using smartphones. Further, businesses, such as utility companies utilize industrial wireless sensors for reporting usage parameters and performing other necessary tasks.

For reasons such as excessive cost and complexity, existing devices utilized with 4G LTE networks have not always been suited to the newer 5G NR networks. Accordingly, in 5G NR Release 17, 3GPP introduced reduced capability (RedCap) devices. Whereas 5G enhanced mobile broadband (eMBB) devices support gigabits per second of throughput in both downlink and uplink, the RedCap devices support a reduced throughput of, for example 150 Mbps in the downlink and 50 Mbps in the uplink, which is sufficient for various IoT use cases. While the RedCap devices can be contrasted with the eMBB devices in terms of throughput, these devices typically have greater throughput than previously available IoT devices used with 4G LTE networks. While 4G LTE networks are expected to coexist with 5G networks, the RedCap devices can offer a higher level of capability, efficiency, and flexibility. The RedCap devices offer higher throughput, lower latency, longer battery life, and stronger security than pre-existing IoT devices.

Although RedCap devices transmit less data and utilize less bandwidth spectrum than enhanced mobile broadband (eMBB) devices, spectrum for RedCap devices is scheduled randomly by default. This default scheduling can result in spectrum fragmentation, which reduces spectral efficiency in a network. For example, because of the randomly scheduled spectrum utilized for the RedCap devices, the eMBB devices may be unable to utilize sufficient continuous bandwidth to optimize spectral efficiency. Accordingly, a solution is needed for increasing efficiency and reducing spectrum fragmentation associated with RedCap devices.

### Overview

Exemplary embodiments provided herein include a method for minimizing spectrum fragmentation associated with RedCap devices. The method includes receiving, at an access node, a request for resources from a wireless device in a network and identifying the wireless device as a reduced capability (RedCap) device. The method further includes allocating a physical resource block (PRB) to the RedCap device based on the request, and scheduling the allocated PRB at an edge of a spectrum bandwidth based on the identification. In yet a further exemplary embodiment, the method includes performing radio resource partitioning (RRP) to ensure sufficient bandwidth for RedCap devices in the network.

In a further aspect, a system is provided for reducing spectrum fragmentation associated with RedCap devices. The system includes a memory storing data and instructions and a processor executing the stored instructions to perform multiple operations. The multiple operations include identifying a wireless device requesting resources as a RedCap device and allocating a physical resource block (PRB) to the RedCap device. The operations further include scheduling the PRB at an edge of available spectrum bandwidth based on the identification.

An additional exemplary embodiment includes an access node configured to minimize spectrum fragmentation associated with RedCap devices. The access node includes at least one antenna receiving a request for resources from a wireless device in a network and a processor identifying the wireless device as a reduced capability (RedCap) device. The processor further allocates a physical resource block (PRB) to the RedCap device based on the request and a scheduler schedules the PRB at an edge of a spectrum bandwidth based on the identification.

In yet additional embodiments, a non-transitory computer-readable mediums may store instructions executed by a processor to perform the operations described above. Further, a processing node performing the operations described herein may be utilized.

### BRIEF DESCRIPTION OF THE DRAWINGS

FIG. 1 depicts an exemplary environment for minimization of spectrum fragmentation in accordance with an embodiment.

FIG. 2 depicts an exemplary RedCap spectrum assignment system in accordance with an embodiment.

FIG. 3 depicts an exemplary access node in accordance with an embodiment.

FIG. 4 depicts an exemplary method for minimizing spectrum fragmentation in accordance with an embodiment.

FIG. 5 depicts a further exemplary method for minimizing spectrum fragmentation in accordance with an embodiment.

FIG. 6 depicts a method for scheduling in order to minimize spectrum fragmentation in accordance with an embodiment.

FIG. 7 depicts a further method for scheduling in order to minimize spectrum fragmentation in accordance with an embodiment.

FIGS. 8A and 8B illustrate bandwidth spectrums having resources allocated in accordance with embodiments set forth herein.

### DETAILED DESCRIPTION

Embodiments provided herein include a method for minimizing or reducing spectrum fragmentation associated with reduced capability (RedCap) devices. Scheduling of physical resource blocks (PRBs) for RedCap devices generally occurs at random by default. Thus the PRBs can be scheduled anywhere with a bandwidth spectrum, causing contiguous carriers to be truncated. Embodiments provided herein therefore aim to reduce spectrum fragmentation in order to provide the continuous spectrum needed to optimize spectral efficiency.

Typical RedCap traffic involves a relatively small amount of data in comparison to the quantity of data transmitted to and from enhanced mobile broadband (eMBB) devices. Generally, data from RedCap devices can utilize up to eight PRBs. With currently available methods, these PRBs can be scheduled anywhere in a bandwidth spectrum, thus fragmenting the spectrum available to the eMBB devices. However, performance objectives of the 5G NR standard require large blocks of contiguous spectrum to operate large channel widths and hence offer users high capacity throughput.

Embodiments described herein propose solutions for minimizing spectrum fragmentation associated with RedCap devices. More specifically, embodiments disclosed herein identify RedCap devices, allocate necessary PRBs to the RedCap devices and schedule the PRBs at a lower end or higher end of the available bandwidth spectrum to avoid fragmentation. Further, embodiments disclosed herein include radio resource partitioning (RRP) in order to ensure that sufficient bandwidth is available to the RedCap devices. Further, a scheduling feature triggers a scheduler to set a PRB start location for physical downlink shared channel (PDSCH) and physical uplink control channel (PUSCH). Accordingly, the scheduler sets the PRB start to occur at a lower or higher edge of an available bandwidth spectrum. For instance, the spectrum bandwidth adjacent guard bands may be the closest available to the lower or higher edge of the spectrum.

An exemplary system described herein includes at least an access node (or base station), such as a next generation NodeB (gNodeB), and a plurality of end-user wireless devices. For illustrative purposes and simplicity, the disclosed technology will be illustrated and discussed as being implemented in the communications between an access node (e.g., a base station) and a wireless device (e.g., an end-user wireless device).

In addition to the systems and methods described herein, the operations for minimizing spectrum fragmentation may be implemented as computer-readable instructions or methods and processing nodes on the network for executing the instructions or methods. The processing node may include a processor included in the access node or a processor included in any controller node in the wireless network that is coupled to the access node.

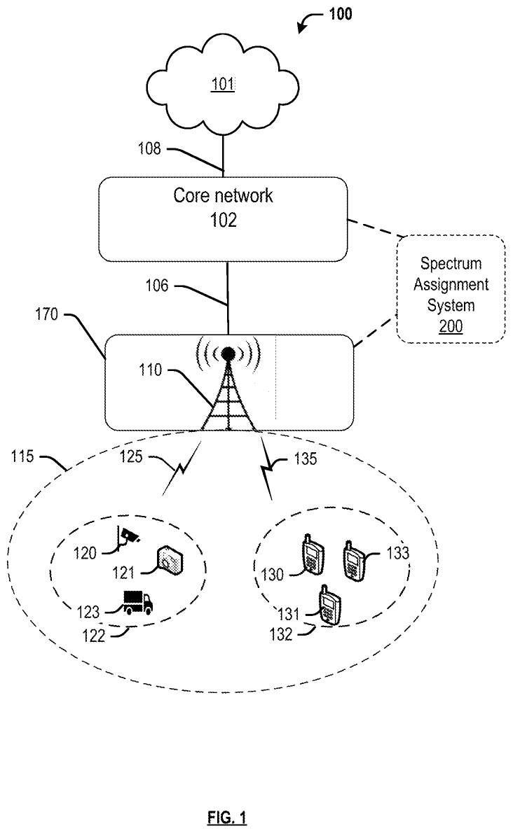

FIG. 1 depicts an exemplary environment 100 for minimizing spectrum fragmentation in a wireless network. In the displayed environment 100, a spectrum assignment system 200 operates to assign bandwidth spectrum for a selected type of wireless device 120, 121, 123 for example, RedCap devices. Accordingly, the spectrum assignment system 200 may operate on a group 122 containing wireless devices 120, 121, and 123 and may not operate on a group 132 including wireless devices 130, 131, and 133 which may, for example, contain eMBB devices.

Environment 100 comprises a communication network 101, core network 102, and a radio access network (RAN) 170 including at least an access node 110. Wireless devices 120, 121, 123, 130, 131, and 133 communicate with the access node 110. Further, a spectrum assignment system 200 operates to reduce spectrum fragmentation associated with RedCap devices 120, 121, and 123. Additionally, components not shown may include, for example, gateway node(s) controller nodes, and additional access nodes.

Access node 110 can be any network node configured to provide communication between end-user wireless devices 120, 121, 123, 130, 131, and 133 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 120, 121, 123, 130, 131, and 133 are illustrated in FIG. 1, any number of access nodes and wireless devices can be implemented within environment 100.

As further described herein, by utilizing antennas, access node 110 can deploy a wireless air interface using one or more frequency bands over one or more coverage areas 115. Higher frequency bands may result in smaller coverage areas and lower frequency bands may result in larger coverage areas. Further, the different sets of antennas can be used to implement various transmission modes or operating modes in each sector, including but not limited to multiple in multiple out (MIMO) (including single user-MIMO, multi-user-MIMO, massive MIMO, beamforming, etc.), carrier aggregation (including inter-band and intra-band carrier aggregation), and different duplexing modes including frequency division duplexing (FDD) and time division duplexing (TDD).

For example, as illustrated herein, some of the antennas of access node 110 can be allocated towards deploying a first carrier using wireless connection 125. Other antennas having a first frequency and other antennas of access node 110 can be allocated towards deploying a second carrier using a second frequency, to which wireless devices attach using wireless connection 135. Additionally, multiple access nodes may be provided, each deploying multiple antennas. Further, different carriers may utilize different modes or the same modes of operation include FDD or TDD modes of operation.

The exemplary operating environment 100 may further include spectrum assignment system 200, which is illustrated as operating between the core network 102 and the RAN 170. However, it should be noted that the spectrum assignment system 200 may operate in the core 102, in the RAN 170, or may be distributed. For example, the spectrum assignment system 200 may utilize components located at both the core network 102 and at the multiple access nodes 110. Alternatively, the spectrum assignment system 200 may be an entirely discrete system operating in conjunction with the RAN 170, core 102 and/or the wireless devices 120, 121, 123, 130, 131, 133.

The spectrum assignment system 200 receives information pertaining to wireless devices from wireless devices 120, 121, 123, 130, 131, and 133. For example, the spectrum assignment system 200 may collect performance parameters, location information, capabilities, and identification information. In embodiments set forth herein, the wireless devices 120, 121, 123, 130, 131, and 133 may send these parameters to the access nodes 110, which convey relevant parameters to the spectrum assignment system 200. The spectrum assignment system 200 analyzes this information in order to determine a type or grouping for a wireless device. For example, the spectrum assignment system 200 may be configured to execute methods including grouping wireless devices and selectively scheduling spectrum for a predetermined group such as a RedCap group. The groups may include, for example, at least one RedCap group 122 and at least one eMBB group 132.

Further, the access node 110 may receive service requests from the wireless devices 120, 121, 123, 130, 131, and 133 and may allocate PRBs based on the requests and schedule the PRBs based on identification of the particular type of device, such as RedCap devices. Requests from other types of devices may be scheduled according to system defaults. Thus, exemplary embodiments described herein aim to reduce spectrum fragmentation associated with RedCap devices. For example, wireless devices grouped into the RedCap group 122 will have PRBs scheduled at a spectrum edge, whereas the eMBB PRBs may be scheduled in accordance with system defaults, for example, randomly within the available bandwidth spectrum.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Further, the access node 110 may communicate with the spectrum assignment system 200 or alternatively may wholly or partially incorporate the spectrum assignment system 200. Thus, the spectrum assignment system 200 may collect data from the wireless devices 120, 121, 123, 130, 131, and 133 and group the wireless devices 120, 121, 123, 130, 131, and 133. The spectrum assignment system 200 may perform processing in order to trigger scheduling at the access node 110.

Wireless devices 120, 121, 123, 130, 131, 133 may be any device, system, combination of devices, or other such communication platform capable of communicating wirelessly with access node 110 using one or more frequency bands deployed therefrom. Wireless devices 120, 121, 123 may be or include RedCap devices, which include IoT devices forming a network of physical objects or things that are embedded with sensors, software, and other technologies for the purpose of connecting and exchanging data with other devices and systems over the Internet. RedCap devices are aimed to lower cost and complexity. The RedCap devices have narrower bandwidths, i.e., 20 MHz in sub-7 GHz or 100 MHz in millimeter wave (mmWave) frequency bands, a single transmit antenna, a single receive antenna, with two receive antennas being optional. The RedCap devices further provide optional support for half-duplex FDD, lower-order modulation, with 256-QAM being optional, and support for lower transmit power. The RedCap devices may also be limited to one or two Rx branches with either one or two MIMO layers being supported, respectively. They also could have a maximum modulation order of 64 QAM rather than the 256 QAM for eMBB devices depending on factors including frequency range The reduced complexity contributes to cost savings, longer battery life due to lower power consumption, and a smaller device footprint, which enables newer designs for a broad range of use cases. Examples of use cases pertaining to RedCap include wearables such as smart watches, wearable medical devices, and low-end AR/VR glasses, video surveillance, industrial sensors, smart grids.

Wireless devices 130, 131, and 133 may be, for example, eMBB devices. The devices may be or include, for example, a mobile phone, a wireless phone, a wireless modem, a personal digital assistant (PDA), a voice over internet protocol (VOIP) phone, a voice over packet (VOP) phone, a soft phone, a home internet (HINT) device, a fixed wireless access (FWA) device as well as other types of devices or systems that can exchange audio or data via access node 110.

Subsequent to sending capabilities to the access node 110, for example, through a capability information message, the wireless devices 120, 121, 123, 130, 131, and 133 may be grouped. Further, upon receiving a request from a wireless device 120, 121, 123 in the RedCap group 122, the spectrum assignment system 200 may operate to reduce spectrum fragmentation by assigning PRBs to RedCap devices and triggering scheduling of these PRBs at an edge of the available bandwidth spectrum.

The core network 102 includes core network functions and elements. The core network may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120, 121, 123, 130, 131, and 133 and is responsible for handling connection and mobility management tasks. The SMF is primarily responsible for creating, updating, and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120, 121, 123, 130, 131, and 133 etc. Wireless network protocols can comprise multimedia broadcast multicast service (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications links 106 may include S1 communications links. Other wireless protocols can also be used. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

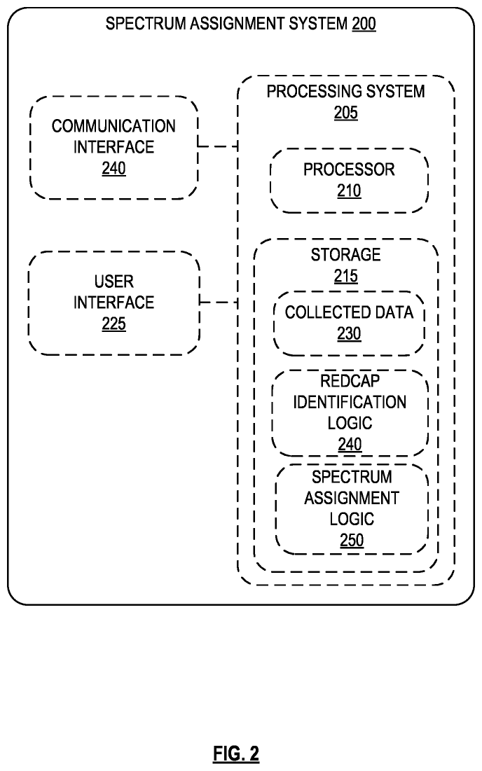

FIG. 2 illustrates a spectrum assignment system 200 in accordance with embodiments described herein. The components described herein are merely exemplary as many different configurations for the spectrum assignment system 200 may be implemented. The spectrum assignment system 200 may be configured to perform the methods and operations disclosed herein to minimize spectrum fragmentation associated with a selected group of wireless devices. In the disclosed embodiments, the spectrum assignment system 200 may be integrated with each access node 110, integrated with the core network 102 or may be an entirely separate component capable of communicating with at least the wireless devices 120, 121, 123, 130, 131, and 133 and the RAN 170. Further, the components of the spectrum assignment system 200 may be distributed so that one or more components is located at an access node 110 and one or more other components are located within a separate processing node or at the core network 102.

The spectrum assignment system 200 may be configured for collecting data transmitted by the wireless devices 120, 121, 123, 130, 131, and 133 to the access nodes 110. To perform processes for spectrum assignment, the spectrum assignment system 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 210 to perform various methods disclosed herein.

Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein. For example, RedCap identification logic 240 may store instructions for identifying RedCap devices based on collected data 230 and spectrum assignment logic 250 may be utilized to set and assign a portion of bandwidth spectrum for the RedCap devices 120, 121, and 123. Additionally, the spectrum assignment logic 250 may be utilized for RRP in order to ensure sufficient bandwidth for RedCap devices 120, 121, and 123. Further, the storage device 215 may store the collected data at 230, which may be or include data collected from the wireless devices 120, 121, 123, 130, 131, and 133 from the RAN 170 or from the core network 102. To perform the above-described operations, the RedCap identification logic 240 and the spectrum assignment logic 250 may be executed by the processor 210 to operate on the collected data 230.

Processor 210 may be a microprocessor and may include hardware circuitry and/or embedded codes configured to retrieve and execute software stored in storage device 215. The spectrum assignment system 200 further includes a communication interface 220 and a user interface 225. Communication interface 220 may be configured to enable the processing system 205 to communicate with other components, nodes, or devices in the wireless network. For example, the spectrum assignment system 200 receives relevant parameters from an access node 110 or from the wireless devices 120, 121, 123, 130, 131, and 133 or from the core network 102.

Communication interface 220 may include hardware components, such as network communication ports, devices, routers, wires, antenna, transceivers, etc. User interface 225 may be configured to allow a user to provide input to the spectrum assignment system 200 and receive data or information from access nodes 110 or the wireless devices 120, 121, 123, 130, 131, and 133. User interface 225 may include hardware components, such as touch screens, buttons, displays, speakers, etc. The spectrum assignment system 200 may further include other components such as a power management unit, a control interface unit, etc.

The location of the spectrum assignment system 200 may depend upon the network architecture. As set forth above, the spectrum assignment system 200 may be located in an access node 110, in a separate processing node, in the RAN 170, in multiple locations, or may be an entirely discrete component. Further, although shown as a single integrated system, the functions of data collection, wireless device identification, and spectrum assignment may be separated and disposed in separate locations.

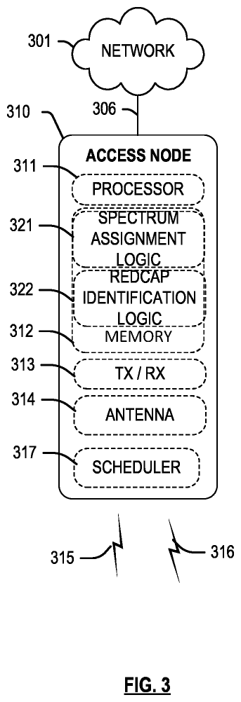

FIG. 3 depicts an exemplary access node 310. Access node 310 is configured as an access point for providing network services from network 301 to end-user wireless devices such as wireless devices 120, 121, 123, 130, 131, and 133 in FIG. 1. Access node 310 is illustrated as comprising a memory 312 for storing logical modules that perform operations described herein, a processor 311 for executing the logical modules, and a transceiver 313 for transmitting and receiving signals via antennas 314. Combinations of antennas 314 and transceivers 313 are configured to deploy wireless air interfaces. Further, the different sets of antennas can be used to implement various transmission modes or operating modes in each sector, including but not limited to MIMO (including SU-MIMO, MU-MIMO, mMIMO, beamforming, etc.), CA, and different duplexing modes including FDD and TDD. Further, access node 310 is communicatively coupled to network 301 via communication interface 306, which may be any wired or wireless link as described above. Scheduler 317 may be provided for scheduling resources based on the presence and performance parameters of the wireless devices 120, 121, 123, 130, 131, and 133. Wireless communication links 315 and 316 may facilitate communication with the wireless devices 120, 121, 133, 130, 131, and 133 in both uplink and downlink directions.

In an exemplary embodiment, memory 312 includes spectrum assignment logic 321 and RedCap identification logic 322 for performing the functions identified above. For example, access node 310 may be configured to group connected wireless devices into eMBB and RedCap groups. The access node 310 may be further configured to allocate and schedule resources within a bandwidth spectrum based on the group or identification of the wireless devices.

Further, as the access node 310 is described as performing the methods described herein, processing nodes, gateway nodes, or other nodes in the RAN 170 may employ methods disclosed to identify RedCap devices. In some embodiments, the spectrum assignment system 200 may be wholly incorporated in the access node 310. However, in other embodiments, the spectrum assignment system 200 may be a separate processing node providing instructions to the access node 310.

Generally, the allocation of PRBs to wireless devices in response to a request can be accomplished at the access node 310 based on the traffic demands and quality of service requirements. The access node 310 may dynamically assign the PRBs to wireless devices as needed to provide for efficient utilization of the available radio resources. The access node 310 may allocate and schedule resource blocks within a frequency spectrum for both downlink (DL) and uplink (UL) transmissions. In embodiments set forth herein, the processor 311 and the scheduler 317 may operate to identify RedCap devices, allocate PRBs to the RedCap devices, and schedule the PRBs within a bandwidth spectrum.

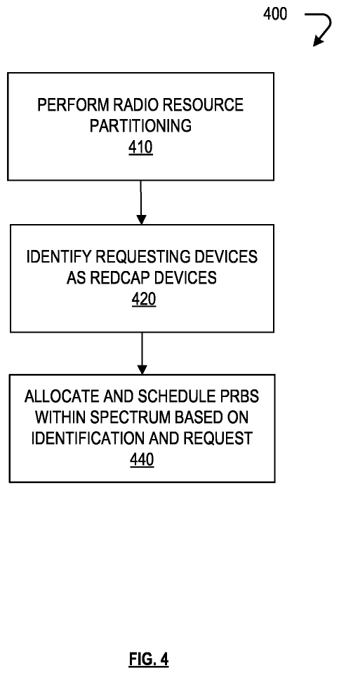

FIG. 4 illustrates an exemplary method 400 for spectrum assignment in order to minimize spectrum fragmentation for selected types of wireless devices in a network. Method 400 may be performed by any suitable processor discussed herein, for example, a processor included in access node 110 or 310, or the processor 210 included in the spectrum assignment system 200. For discussion purposes, as an example, method 400 is described as being performed by the processor 210 included in the spectrum assignment system 200.

Method 400 starts in step 410, in which the processor may perform radio resource partitioning (RRP). This process assigns a percentage of available spectrum to types of devices in the network. The process may be performed to ensure that all of the devices in the network, for example, eMBB devices and RedCap devices, have sufficient available spectrum. For example, using RRP, the processor 210 may assign five to ten percent of the available spectrum to RedCap devices.

The method continues in step 420, in which the processor 210 may identify devices in the network as RedCap devices. These devices can be identified in various ways. In one embodiment, RedCap devices may self-identify to the network by utilizing key identifiers unique to a RedCap device at a lower layer, namely the media access control (MAC) layer. Accordingly, the RedCap devices would convey a RedCap specific identity in the form of a logical channel identifier (LCID). In so doing, the receiving access node 110 will be notified and act accordingly. As an alternative, the access node 110 may assign access parameters that are reserved specifically for RedCap devices. In utilizing these parameters, the RedCap device makes the access node 110 aware of its classification. Further, 3GPP Release 17 introduced an indication to determine during the random-access procedure, whether a wireless device has reduced capabilities compared to legacy devices. However, this step may be optional as the RedCap devices may alternatively self-identify within a radio resource control (RRC) connection request or in response to a broadcast message.

In step 430, the processor 210 may perform or trigger allocation and scheduling of PRBs. As set forth above, the wireless devices may allocate resources blocks and schedule the resource blocks within the bandwidth spectrum based on the identification of devices as RedCap devices. Further, during each scheduling phase, in the uplink channel, wireless devices 120, 121, 123, 130, 131, and 133 transmit buffer status information and buffer size to the access node 310 via PUCCH. After receiving all the scheduling requests, the access node 110 or spectrum assignment system processor 210 allocates PRBs based on a stored scheduling algorithm through PDCCHs.

In some embodiments, allocation and scheduling may be performed by the spectrum assignment system 200. However, the spectrum assignment system 200 may operate to determine allocation and spectrum assignment, but provide instructions to the scheduler of the access node 310 in order to trigger scheduling. As set forth herein, the scheduling occurs in a manner calculated to reduce spectrum fragmentation by utilizing spectrum edges.

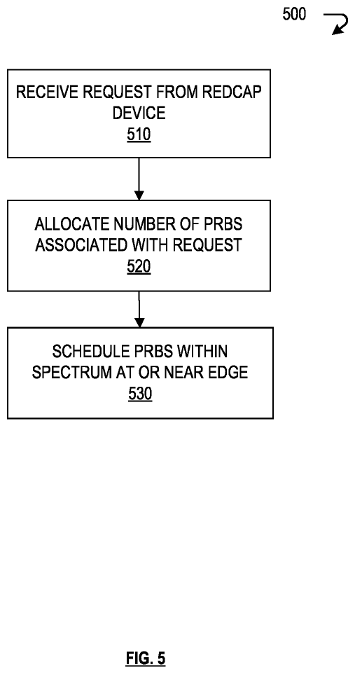

FIG. 5 depicts an exemplary method 500 for allocation and scheduling responsive to a request from a RedCap device in accordance with embodiments described herein. Method 500 may be performed by any suitable processor discussed herein, for example, a processor included in access node 110 or 310, or the processor 210 in the coverage extension system 200. Further, the method may be performed by the scheduler 317 in combination with the processor 311 or 210. For discussion purposes, as an example, method 500 is described as being performed by a processor 311 included in the access node 310 in combination with the scheduler 317.

In step 510, the access node 310 may receive a request for services from a RedCap device. The processor 311 may determine that the wireless device sending the request is a RedCap device in the manner described above. In step 520, the processor 311 may allocate a number of PRBs associated with the request based on the amount of data that will be transmitted. For example, anywhere from one to eight PRBs may be allocated to satisfy a service request from a RedCap device.

In step 530, the scheduler 317 schedules the allocated PRBs within a bandwidth spectrum at or near an edge of the bandwidth spectrum in order to minimize spectrum fragmentation. Thus, with PRBs for the RedCap devices scheduled at the edges of the spectrum, more continuous spectrum is available for eMBB devices in the middle of the bandwidth spectrum. Further, in the event that RRP is performed as described above with respect to FIG. 4, the RedCap devices are allotted a predetermined percentage of available spectrum. In accordance with embodiments, set forth herein, the allotted percentage will be consumed at the edges of the bandwidth spectrum.

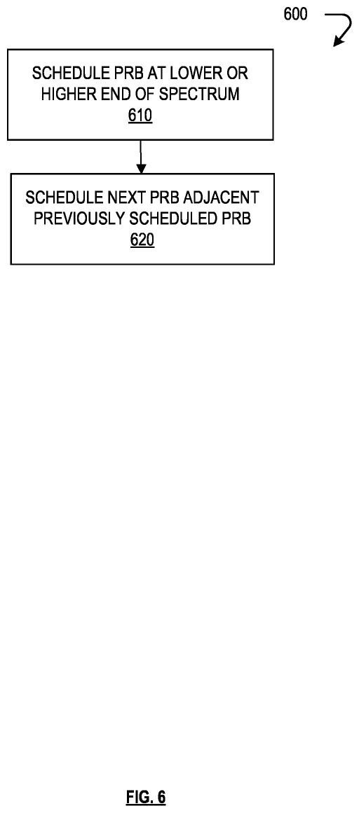

FIG. 6 illustrates a method 600 for minimization of spectrum fragmentation in accordance with embodiments described herein. Method 600 may be performed by any suitable processor discussed herein, for example, a processor included in access node 110 or 310 or the processor 210 included in the spectrum assignment system 200. Alternatively or additionally, the method may be performed by the scheduler 317 utilizing stored spectrum assignment logic. For discussion purposes, as an example, method 600 is described as being performed by the scheduler 317.

In step 610, the scheduler 317 schedules a first PRB at a lower or higher end of the bandwidth spectrum. For the next or additional PRB, in step 620, the scheduler 317 schedules the next PRB adjacent to the previously scheduled PRB.

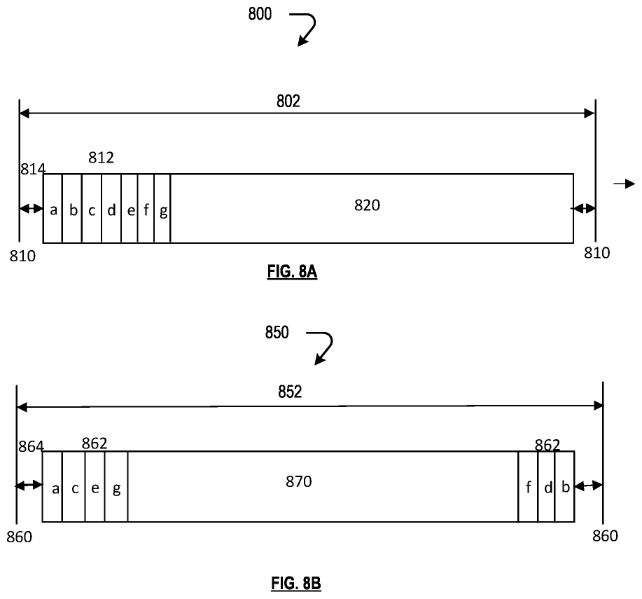

Accordingly, the method of FIG. 6 will produce the scheduling scenario illustrated in FIG. 8A. With reference to FIG. 8A, PRBs 812 for a RedCap device are allocated and are scheduled within a spectrum 802 close to a spectrum edge 810. As explained in FIG. 6, a group of PRBs 812 is scheduled adjacent to the spectrum edge 810 and a guard band 814. PRB “a” is the first resource block scheduled, followed sequentially by PRBs “b”−“g”. Accordingly, the remainder of the spectrum band 820 can be utilized for eMBB devices. Although FIG. 8A illustrates scheduling PRBs 812 on a left end of the spectrum band, the resource blocks could alternatively be scheduled on a right end of the spectrum band from right to left.

As an example, the entire spectrum band 802 may be, for example, 100 MHZ. Using RRP, 10% of this spectrum band may be reserved for RedCap devices. In this example, the scheduler 317 would assign PRBs 812 at the left or lower end of the bandwidth spectrum. In embodiments provided herein, the scheduling could occur either on uplink or downlink or on both the uplink and the downlink.

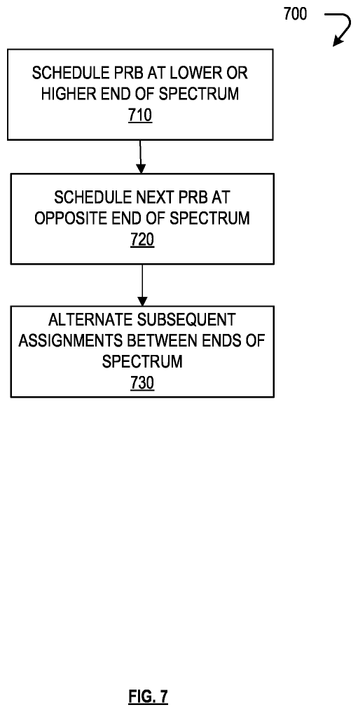

FIG. 7 illustrates a method 700 for minimization of spectrum fragmentation in accordance with embodiments described herein. Method 700 may be performed by any suitable processor discussed herein, for example, a processor included in access node 110 or 310 or the processor 210 included in the spectrum assignment system 200. Alternatively or additionally, the method may be performed by the scheduler 317 utilizing stored spectrum assignment logic. For discussion purposes, as an example, method 600 is described as being performed by the scheduler 317.

In step 710, the scheduler 317 schedules a RedCap PRB at a lower or higher end of the bandwidth spectrum. In step 720, the scheduler 317 schedules a next or additional PRB at an opposite end of the bandwidth spectrum. Finally, in step 730, the scheduler 317 schedules additional PRBs by alternating assignments between ends of the bandwidth spectrum.

Accordingly, the method of FIG. 7 will produce the scheduling scenario illustrated in FIG. 8B. With reference to FIG. 8B, a first PRB “a” for a RedCap device is allocated and are scheduled within a spectrum 852 close to a spectrum edge 860 and guard band 864. As explained with respect to FIG. 7, a next resource block “b” is scheduled at a closest available location to an opposite or right edge 860 of the spectrum 852. Resource block “c” is then scheduled at the left edge adjacent resource block “a”. Alternating again, resource block “d” is scheduled at the right edge adjacent resource block “b” and so on. Accordingly, the remainder of the spectrum band 870, which is in the middle of the spectrum bandwidth 852 can be utilized for eMBB devices. Although FIG. 8B illustrates starting on a left side and moving to the right, further embodiments encompass starting on the right side of the spectrum 852 and moving to the left.

In some embodiments, methods 400, 500, 600, and 700 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400, 500, 600, and 700 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving, at an access node, a request for resources from a wireless device in a network;
identifying the wireless device as a reduced capability (RedCap) device; and
allocating a physical resource block (PRB) to the RedCap device based on the request, and
scheduling the PRB at an edge of a spectrum bandwidth based on the identification.

2. The method of claim 1, further comprising performing radio resource partitioning (RRP) to ensure sufficient bandwidth for RedCap devices in the network.

3. The method of claim 2, further comprising reserving between five percent and ten percent of the spectrum bandwidth for the RedCap devices using RRP.

4. The method of claim 1, further comprising allocating at least one additional PRB to the RedCap device and scheduling the additional PRB adjacent to the allocated PRB.

5. The method of claim 1, further allocating at least one additional PRB to the RedCap device and scheduling the additional PRB at an opposite edge of the spectrum bandwidth.

6. The method of claim 1, further comprising receiving a request from an enhanced mobile broadband (eMBB) device, allocating a corresponding PRB to the eMBB device, and allocating the corresponding PRB within the spectrum bandwidth to the eMBB device.

7. The method of claim 1, further comprising allocating the PRB to the RedCap device for uplink transmissions using a physical uplink control channel (PUCCH).

8. The method of claim 1, further comprising allocating the PRB to the RedCap device for downlink transmissions using a physical downlink shared channel (PDSCH).

9. The method of claim 1, further comprising scheduling the PRB at a scheduler of a gNodeB.

10. A system comprising:
a memory storing data and instructions; and
a processor executing the stored instructions to perform multiple operations, the operations comprising;
identifying a wireless device requesting resources as a reduced capability (RedCap) device;
allocating a physical resource block (PRB) to the RedCap device; and
scheduling the PRB at an edge of a spectrum bandwidth based on the identification.

11. The system of claim 10, the operations further comprising performing radio resource partitioning (RRP) to ensure sufficient bandwidth for RedCap devices in a network.

12. The system of claim 11, the operations further comprising reserving between five percent and ten percent of the spectrum bandwidth for the RedCap devices using RRP.

13. The system of claim 10, the operations further comprising allocating at least one additional PRB to the RedCap device and scheduling the additional PRB adjacent to the scheduled PRB.

14. The system of claim 10, the operations further comprising allocating at least one additional PRB to the RedCap device and scheduling the additional PRB at an opposite edge of the spectrum bandwidth.

15. The system of claim 10, the operations further comprising, allocating a corresponding PRB to an eMBB device and randomly scheduling the corresponding PRB within the spectrum bandwidth to the EMBB device.

16. An access node comprising:
at least one antenna receiving a request for resources from a wireless device in a network;
a processor identifying the wireless device as a reduced capability (RedCap) device; and
a scheduler allocating a physical resource block (PRB) to the RedCap device based on the request and scheduling the PRB at an edge of a spectrum bandwidth based on the identification.

17. The access node of claim 16, further comprising a memory storing instructions.

18. The access node of claim 17, wherein the processor executes RedCap identification logic stored in the memory to identify the wireless device as a RedCap device.

19. The access node of claim 17, wherein the scheduler executes spectrum assignment logic stored in the memory to perform PRB scheduling.

20. The access node of claim 16, wherein the processor performs radio resource partitioning (RRP) to ensure sufficient bandwidth for RedCap devices in the network.
